(19) United States
(12) Patent Application Publication
(10) Pub. No.: US 2004/0263975 A1
(43) Pub. Date: Dec. 30, 2004

(54) Method for producing a polarization-affecting viewing element

(75) Inventor: Peter Schmitt, Wurzburg (DE)

Correspondence Address: THE FIRM OF KARL F ROSS, 5676 RIVERDALE AVENUE, PO BOX 900, RIVERDALE (BRONX), NY, 10471-0900, US

(73) Assignee: METRONIC AG

(21) Appl. No.: 10/876,252

(22) Filed: Jun. 24, 2004

(30) Foreign Application Priority Data
Jun. 25, 2003 (DE) 10328743.4

(51) Int. Cl. G02B 5/30

(52) U.S. Cl. 359/500

(57) ABSTRACT

The invention relates to a method for producing a polarization-affecting viewing element, in particular for producing/viewing three-dimensional images of printed matter or display units, wherein at least one coating agent is applied to a substrate by means of a printing process, said coating agent having polarization-affecting reaction applied to at least two adjacent zones of the substrate in such a way that the coating agent in adjacent zones has a different polarization-affecting reaction. Furthermore, the invention relates to a viewing element and a display device for displaying freely programmable information.

The invention relates to a method for producing a polarization-affecting viewing element, in particular for producing/viewing three-dimensional images, e.g. monochromatic or multicoloured images, by means of printed matter or display device. Furthermore, the invention relates to a viewing element which is produced with the method and a display device for displaying freely programmable information by means of individually drivable display elements with a viewing element of this type.

Various techniques are known from various applications to produce so-called three-dimensional or also pure three-dimensional images. The best known form is holography which alone is capable of showing pure three-dimensional images of objects and also objects artificially produced in the computer.

Other techniques work with lenticular screens or slit-like screens, others again use colour filters or polarization filters. These latter techniques are very suitable in principle for inexpensive duplication since the images can be conventionally printed in large editions. The image patterns used which serve to show stereo images, plastic three-dimensional representations or film sequences are merely interpolated in one another by means of electronic data processing. The print pattern, a film and the printing plate are usually produced for a conventional printing machine.

Compared to a conventional two-dimensional printing pattern, the difference is primarily in the demand for higher resolution which must be made on the printing technique since several images, however, at least two images, are compressed into one another with this method and the print resolution must thus be higher by the factor of the number of images used. Subsequent to the printing, the viewing element, which visually reverses the interpolation for the viewer, must now be applied to the printed surface.

Lenticular screens, which are produced as films or plates, or slit-like masks can be used as viewing elements. These must now be applied with great accuracy to the printed surface of various materials, e.g. a web of paper or plastic film wound on rollers, a sheet of paper of film or a smaller object made of paper or plastic.

One difficulty of these is in the accuracy with which these elements must be applied, in particular, if a flexible material is used as printed material, since it is then difficult to guarantee an accurate fit over the entire surface. A further disadvantage is that the process of applying it can usually not be accomplished within the printing machine since the viewing elements are often too thick and can therefore not be processed in a printing machine.

The same restriction also applies to polarization films which make only the image in question visible to each eye of the viewer in association with polarization spectacles. These films are usually also too thick and inflexible and cannot be processed in current printing machines. A further restriction of these films is that each film has only one direction of polarization. However, for a functional representation e.g. of a stereo image, closely adjacent zones of various polarization directions are required, for example, strips with alternating horizontal and vertical polarization. In this case, the width of such strips should be less than 1 mm.

Display elements can also be commercially obtained in many different designs for a great variety of applications. Thus, there are small and minuscule displays for displaying numbers or symbols as they are used, for example, in the form of liquid crystal display units (LCD displays) in watches or mobile telephones.

Larger displays are found in the computer field in the form of liquid crystal screens or screens with cathode-ray tubes. However, all these displays are used to show a 2-dimensional image.

Only recently have systems come sporadically on the market which supposedly enable a three-dimensional view. Thus, one is often working with two LCD displays which are integrated in a pair of spectacles to be worn by the viewer.

The disadvantage in this case is that only one viewer sees the information, the control for which requires an additional apparatus expenditure and that the spectacles are expensive. In addition, the relatively high weight only offers a slight wearing comfort over a longer period of time. Other systems work with electrically switched linear polarization filters in front of conventional screens. Dependent on the voltage applied, the light emitted by the screen in this case is polarized horizontally or vertically. The viewer must also wear spectacles in this case which merely consist of a thin film.

A polarization filter is placed in front of each eye, the polarization planes of which are at a right angle to one another. As a result, only horizontally or vertically polarized light reaches each eye. Switching the polarizer in front of the screen is now used to transfer the correct partial image to each eye of the viewer by synchronizing the image contents with the switching of the polarizer. If the viewer holds his head with the polarization spectacles parallel to the polarization filter in front of the display, then he sees a stereographic image which can produce a highly spatial representation.

In this case, the expensive, large-sized polarizer in front of the screen, which most often reacts only sluggishly, is disadvantageous. Thus, a flickering image appears since the entire image repetition frequency now divides it into two images and each eye thus only sees half of the image repetition frequency. Moreover, the viewer may not tilt his head since undesirable image parts of the respective other eye can otherwise be viewed which results in double images.

The object of the invention is to provide a method with which it is possible to produce duplications of monochromatic or multicoloured stereo images, 3-dimensional and/or moving images using commercial printing machines. Furthermore, it is the object of the invention to realize a method which enables a viewer to see a stereographic three-dimensional view with conventional display units without the necessity for expensive additional devices or large-scale structural apparatus. The method should also make it possible to retrofit display units which have already been manufactured with the capability of this viewing element.

According to the invention, this object is solved in that a coating agent with a polarization-affecting reaction on at least two adjacent zones of the substrate is applied to a substrate by means of a printing process, e.g. by means of offset printing, screen printing, flexo printing or intaglio, in such a manner that the coating agent has different polarization-affecting reaction in adjacent zones. Light which emanates from the substrate, e.g. by reflection or by emission, thus experiences a different effect of the polarization in the adjacent zones. For example, the light from different zones can exhibit various linear or also various elliptical, in particular, circular polarization, so that it is allowed to pass through or blocked by adequately selected aids, e.g. polarization spectacles.

Thus, there are always at least two groups of zones which can be interpolated in one another in the most varied manner, the polarization-affecting reaction of each individual zone within a group being the same and the polarization-affecting reaction in zones of different groups being different.

In one approach, as known in the prior art, i.e. e.g. with the polarization spectacles, it can thus be ensured that light which comes from or has passed through a zone with a first polarization-affecting reaction can only be perceived with the left eye of a viewer, whereas light which comes from or has passed through a zone with another polarization-affecting reaction can only be perceived with the right eye of a viewer or vice versa.

Under the term polarization-affecting reaction, one basically understands this to be the possibility of changing light in a polarization property, i.e. e.g. to make it circular from a linear polarized light or vice versa or to also only allow a specific polarization direction (linear, elliptical, circular) to pass through.

To attain the polarization-affecting reaction, a coating agent with a birefractive effect can be applied, so that the coating agent has a different birefractive effect in adjacent zones. Preferably, a coating agent is used for this purpose which comprises liquid crystals, in particular nematic, cholesterol or smectic liquid crystals of e.g. the firm Merck KGaA. These liquid crystals can be present particularly in a mesomorphous melt or in solution with e.g. one or more alcohols, so that they can be processed in printing machines. The coating agent can comprise one or more fixable binding agents (acrylates, epoxy resins), additives, pigments, photo initiators, coloring matter or the like.

Liquid crystals can exhibit different properties depending on their composition. A majority of the commercially produced and obtainable liquid crystals is used in electronics, where these substances are used in display elements. The property of the liquid crystals to align themselves vis-à-vis one another within a thin layer of only a few micrometers and to turn the polarization plane by incident light is used in this application. To make this property visible, the liquid crystal layer is placed between polarizers, the first polarizer polarizing the incident light and the second polarizer being used as an analyzer for the light reaching through the liquid crystal layer. If the polarization plane of the light arriving at the analyzer does not agree with the polarization plane of the analyzer, then no light can pass the analyzer and the display element appears dark.

The property of the liquid crystals to turn the polarization plane by incident light can be influenced by applying an electric field to the liquid crystal layer such that this effect is suppressed. This results in two circumstances which enable one to produce an electrically controllable display element. The liquid crystals in the displays are thereby present in their liquid form, since a dynamic operation is required in this case.

This polarization effect of the liquid crystals can be fixed by embedding them in a polymer matrix. If one uses, for example, radiation-hardening polymers as polymer matrix, then these can be processed in conventional printing machines which are equipped for radiation-hardening dyes and lacquers.

Thus, it is possible to print the at least one coating agent e.g. on a substrate which comprises at least two image informations which are interpolated by zone, wherein the zones which belong to a first image information are covered by a coating agent having e.g. a first polarization-affecting reaction and the zones which belong to another e.g. second image information are covered by a coating agent of another e.g. second polarization-affecting reaction. In this case, the image information can be applied e.g. to the substrate to be coated prior to coating by means of a conventional printing process.

The image information can represent e.g. an object consisting of slightly different directions or successive motions, whereby this image information can be interpolated e.g. in the form of individual images of a stereographic or 3-dimensional representation, as is known in the prior art. If every image information is now divided into zones of smaller partial image informations, the zones of different image information are interpolated by adjacent rows and the zones belonging to an image information each printed by means of a printing process with a coating agent of a specific polarization-affecting reaction, e.g. liquid crystals, then a viewer can recognize, e.g. a 3-D image with suitably selected polarization spectacles.

The interpolation can be designed in any arrangement desired, however, it must correspond exactly to the later arrangement of the polarization elements, i.e. the same zone arrangement of the polarization-affecting application. This interpolation is advantageously accomplished by means of a computer and appropriate software.

Printing plates can be produced in successive steps in a known manner from the data thus produced. In a conventional printing machine, the images and texts are now printed with these printing plates in a conventional manner, monochromatically or polychromatically, on the printing material or any substrate desired.

In a subsequent process, the arrangement of the polarization elements or zones previously selected in the preprinting stage can be printed at the required points of the e.g. clear liquid crystal lacquer as coating agent. This can take place in two different lacquer mechanisms, since the individual image must be offered to each eye of the viewer and two different polarization directions are thus required.

In this case, the polarizations are polarized either linear in the horizontal and vertical directions or circular in the left circular and right circular directions. To assist in the alignment of the liquid crystals, known processes such as the prior rubbing of the surface, electric or magnetic fields can be used or an additional orientation layer can be applied.

So that the viewer recognizes the 3-dimensional effect, he requires a polarization filter in front of each eye which only permits the light belonging to this eye to pass through. For example, an image each is printed for the left and the right eye. Each of these images is overprinted with another polarizing lacquer, in this way for example, the image for the left eye with a left-turning polarization lacquer and the image for the right eye with a right-turning polarization lacquer. To ensure that the viewer receives the correct viewing impression, he needs the correct polarization filter in front of each eye, in the example in front of the left eye, a left-turning polarizer and in front of the right eye a right-turning polarizer.

The function of each polarizer is to allow light intended for this eye to pass through. It is thereby insignificant whether the left and right images are printed adjacent to one another or are printed so as to be interpolated, as long as the polarizing lacquer is applied to the printed images in the same interpolated manner as the printing pattern. The lacquer should thereby cover the printed images as completely as possible, however, not overlap one another to avoid undesirable effects.

Similarly, it can also be printed on a transparent substrate which e.g. can, in addition, itself have a polarization-affecting reaction. A printed substrate of this type can be placed e.g. as a viewing element in front of a conventional display unit with freely programmable display elements, i.e. e.g. pixels.

The display unit can then be programmed such that, as described above with respect to a printed substrate, the display shows at least two images interpolated by zones, whereby a viewer with appropriately selected polarization spectacles of a conventional display unit sees a three-dimensional image by appropriatley adapting the zones of the printed substrate to the zones of the display shown. This embodiment is especially advantageous since the programmability makes it possible to be able to view moving images or films in a three-dimensional manner.

Preferably, in this case, adjacent zones of coating agents with different polarization-affecting reaction are arranged in such a manner that their form and/or arrangement corresponds to a form and/or arrangement of the imaging display units of a display unit. In this way, a specific polarization property can be allocated to each individual imaging display element of a display unit by placing a viewing element produced according to the invention in front of it.

In the application in LCD display units, e.g. displays, a transparent birefractive layer is applied to e.g. the outer polarization film of the LCD display which represents a transparent substrate within the meaning of the invention such that the light coming from the display and linearly polarized at first has e.g. a circular polarization after passing through the birefractive layer. Since two different polarization states are required for a stereographic viewing, the coating is applied by zones such that adjacent zones have a different circular polarization. The arrangement of the zones can thereby be in strips, square, point-like or as desired, whereby it is advantageous to adapt it to the point pattern of the display point preset by the display.

Applying the birefractive layer advantageously takes place by means of printing processes, the printing technique can be any one desired. Thus, a screen printing process or a tampon printing process can be most suitable for finished display elements. If the coating is applied to the display prior to assembly of the polarization filter, then a flexo printing process, offset process or generally a rotary printing process can be more advantageous. The use of freely programmable inkjet printers can also be advantageous.

The orientation of the applied layer takes place e.g. by pretreating the substrate, such as rubbing or applying an orientation layer, however, it can also be accomplished by specific use of electric or magnetic fields. To produce different birefractive properties of adjacent zones, the birefractive layer can consist of variously composed lacquers. In this case, the birefractive layers are applied successively. In another embodiment, when using the same lacquer in successive printing units, the orientation on the printing areas between the printing mechanisms must be changed in such a way that the desired orientation of the birefractive layer appears after printing.

In another embodiment, the coating can be applied directly to a linear polarizing film or plane, it being possible to use the element coated in this way as a filter plate to be attached externally in front of a conventional screen or monitor. Existing monitors or screens can thus be retrofitted to form a stereogrpahic display unit.

In all embodiments, the zone arrangement can fundamentally be any arrangement desired. Preferably, adjacent zones are arranged adjacent to one another in a strip-like manner by means of the printing processes. The substrates to be printed can also have any form desired, e.g. also curved, orbital or represent any objects desired, i.e. uneven substrates can also be printed.

With the process according to the invention, a coating agent comprising a single liquid crystal can be applied to a substrate e.g. in a printing step, the liquid crystals preferably orientating themselves automatically and differently in adjacent zones, in particular, thereby that the printed zones have an agent acting in an orientating manner on the liquid crystals, in particular structures, which act in an orientating manner on the liquid crystals by a force action.

For example, a further coating agent can be applied beforehand to the zones to be printed, said coating agent producing an orientation of the liquid crystals by zone in a desired effect. The zones can have a structure which exerts a force on the liquid crystals, whereby the structure can be mechanical or electrostatic. The directed application of electric or magnetic fields can also set a preferred direction in the zones. The printed substrates can also be treated thermally in a varied manner in a directed local manner, in particular in various zones, e.g. by heating.

Alternatively, different coating agents, in particular with different liquid crystals, can be applied in adjacent zones in successive printing steps. The same coating agent can also be applied in successive printing steps in adjacent zones, the substrate being turned between the printing steps or the orientation effect of the zones to be printed changed.

The essential point for the method according to the invention vis-à-vis the prior art is to use a coating instead of the known polarization films, said coating having different polarization properties dependent on the method or their composition. A coating which consists entirely or partially of liquid crystals and which can be hardened by application to a surface of the substrate is used. For example, the hardening can take place by radiation, by oxidative hardening or by physical drying.

1. A method for producing a polarization-affecting viewing element, in particular for producing/viewing three-dimensional images of printed matter or display units, characterized in that at least one coating agent is applied to a substrate by means of a printing process, said coating agent having a polarization-affecting reaction applied to at least two adjacent zones of the substrate in such a way that the coating agent in adjacent zones has a different polarization-affecting reaction.

2. The method according to claim 1, characterized in that a coating agent with birefractive effect is applied, so that the coating agent has a different birefractive effect in adjacent zones.

3. The method according to claim 1, characterized in that a coating agent is applied which comprises liquid crystals, in particular, nematic, cholesterol or smectic liquid crystals.

4. The method according to claim 1, characterized in that a coating agent comprising a liquid crystal is applied to a substrate in a printing step and that the liquid crystals orientate differently in adjacent zones, in particular, in that the printed zones have an agent, in particular structures, acting in an orientating manner on the liquid crystals, said structures acting in an orientating manner on the liquid crystals by a force action.

5. The method according to claim 1, characterized in that different coating agents, in particular with different liquid crystals, are applied in adjacent zones in successive printing steps.

6. The method according to claim 1, characterized in that the same coating agent is applied in adjacent zones in successive printing steps, the substrate being turned between the printing steps or the orientation action of the zones to be printed being changed.

7. The method according to claim 1, characterized in that a transparent substrate is printed on, in particular, which has a polarization-affecting reaction.

8. The method according to claim 1, characterized in that a substrate is printed on which comprises at least two image informations which are interpolated by zone, the zones of one image information being covered by a coating agent with a polarization-affecting reaction and the zones of another image information being covered by a coating agent of another polarization-affecting reaction.

9. The method according to claim 1, characterized in that adjacent zones are arranged beside one another in a strip-like manner.

10. The method according to claim 1, characterized in that adjacent zones are arranged by coating agents with different polarization-affecting reaction such that their form and/or arrangement correspond to a form and/or arrangement of the image-generating display units of a display device.

11. A viewing element produced according to a method according to claim 1.

12. A display device for displaying freely programmable information by means of individually controlled display elements, wherein a viewing element according to claim 11 is arranged in front of the display device in viewing direction.

13. Use of a display device with individually controlled display elements and with a viewing element according to claim 11 for the visually three-dimensional representation of still or moving images.
